(19) United States
(12) Patent Application Publication
(10) Pub. No.: US 2009/0207523 A1
(43) Pub. Date: Aug. 20, 2009

(54) MAGNETIC RECORDING MEDIUM AND MAGNETIC RECORDING APPARATUS

(75) Inventors: Takayuki Kawabe, Kawasaki (JP); Haruhiko Izumi, Kawasaki (JP); Yasuyuki Ozawa, Kawasaki (JP); Takuya Kamimura, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/364,125

(22) Filed: Feb. 2, 2009

(30) Foreign Application Priority Data
Feb. 14, 2008 (JP) 2008-033810

(51) Int. Cl. G11B 5/127; G11B 5/82

(52) U.S. Cl. 360/110; 360/135; G9B/5.293; G9B/5.04

(57) ABSTRACT

A magnetic recording medium formed on a substrate. The magnetic recording medium includes a data region including a plurality of magnetic dots arranged at predetermined positions on the substrate, for recording information; and a servo region for specifying the positions of the magnetic dots, the servo region including a plurality of magnetic segments arranged at predetermined positions on the substrate, each of the magnetic segments being smaller than each of the magnetic dots.

### CROSS-REFERENCE TO RELATED APPLICATIONS

This application is based upon and claims the benefit of priority of the prior Japanese Patent Application No. 2008-033810, filed on Feb. 14, 2008, the entire contents of which are incorporated herein by reference.

### FIELD

The embodiments discussed herein are related to a magnetic recording apparatus for recording and reproducing information.

### BACKGROUND

In recent years, a magnetic recording medium of patterned media type is becoming a focus of attention as a technology for improving the recording capacity of a magnetic recording apparatus. The magnetic recording medium of patterned media type is a recording medium in which recordable magnetic crystal grains that are fine and equally-sized are arranged at predetermined positions on a substrate. The magnetic recording medium of patterned media type is able to improve recording density in area in principle.

The disk-shaped magnetic recording medium (magnetic disk medium) is formed so that a pattern (data pattern) that includes a first magnetic substance for recording and reproducing information and a pattern (servo pattern) that includes a second magnetic substance for positioning a magnetic head to the first magnetic substance are formed on a substrate. The servo pattern formed on the substrate includes a large-area pattern, such as a synchronization signal generating portion (preamble part) that is long in the radial direction of the disk (see Japanese Laid-open Patent Publication No. 2005-108361, Japanese Laid-open Patent Publication No. 2005-100499, and Japanese Laid-open Patent Publication No. 2006-344328).

The magnetic disk medium of patterned media type forms a bit using a magnetic portion formed of magnetic polycrystal and a nonmagnetic portion that is located around the magnetic portion and that includes no magnetic substance. In the magnetic disk of patterned media type, the magnetic substance made of large-area polycrystal, like the magnetic portion of the servo pattern, easily inverts its magnetization, that is, has a low coercive force. Such magnetization of the magnetic substance is not stably held against an external magnetic field. Thus, this adversely affects reliability of a reproduced signal.

### SUMMARY

According to an aspect of the invention, a magnetic recording medium formed on a substrate includes a data region including a plurality of magnetic dots arranged at predetermined positions on the substrate, for recording information; and a servo region for specifying the positions of the magnetic dots, the servo region including a plurality of magnetic segments arranged at predetermined positions on the substrate, each of the magnetic segments being smaller than each of the magnetic dots.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic configuration diagram that illustrates an embodiment of a magnetic recording apparatus that is provided with a magnetic recording medium.

FIG. 2A and FIG. 2B are conceptual plan views that illustrate a sector structure of a magnetic disk medium according to the embodiment, provided for a magnetic disk apparatus.

FIG. 3A is a schematic plan view that illustrates a surface of the magnetic disk medium according to the embodiment.

FIG. 3B is a conceptual schematic view that illustrates a magnetized state of a data region and servo region.

FIG. 4 is a schematic view that illustrates a granular structure on the surface of the magnetic recording medium.

FIG. 5 is a schematic plan view that illustrates an example of a surface shape of a fine position detecting portion on the surface of the existing magnetic recording medium.

FIG. 6 is a schematic plan view that illustrates an example of a surface shape of a fine position detecting portion on the surface of the existing magnetic recording medium.

FIG. 7 is a block diagram of a servo signal demodulating circuit in the magnetic disk apparatus according to the embodiment.

FIG. 8 is an operation timing chart of the servo signal demodulating circuit in the magnetic disk apparatus according to the embodiment.

FIG. 9 is an enlarged schematic view of a synchronization signal generating portion within the servo region of the magnetic recording medium according to the present embodiment illustrated in FIG. 3.

FIG. 10A to FIG. 10C are schematic views that illustrate the relationship between the size of a magnetic segment provided on the substrate and magnetization and demagnetization generated from the magnetic segment.

FIG. 11 is a conceptual view that illustrates the relationship between magnetization and demagnetizing field generated from a plurality of magnetic segments on the surface of the magnetic recording medium according to the embodiment.

FIG. 12 is a schematic view that illustrates a servo pattern having a synchronization signal generating portion on the surface of the existing magnetic recording medium.

FIG. 13 is a schematic view that illustrates a synchronization signal generating portion on the surface of the magnetic recording medium according to the embodiment.

FIG. 14 is a schematic view that illustrates a synchronization signal generating portion on the surface of the magnetic recording medium according to another embodiment.

FIG. 15 is a schematic view that illustrates a synchronization signal generating portion on the surface of the magnetic recording medium according to another embodiment.

FIG. 16 is a schematic view that illustrates a synchronization signal generating portion on the surface of the magnetic recording medium according to another embodiment.

FIG. 17 is a schematic view that illustrates a synchronization signal generating portion on the surface of the magnetic recording medium according to another embodiment.

FIG. 18 is a schematic view that illustrates a synchronization signal generating portion on the surface of the magnetic recording medium according to another embodiment.

FIG. 19 is a schematic view that illustrates a synchronization signal generating portion on the surface of the magnetic recording medium according to another embodiment.

FIG. 20 is a schematic view that illustrates the servo region on the surface of the magnetic recording medium according to another embodiment.

FIG. 21 is a schematic view that illustrates a fine position detecting portion and a synchronization signal generating portion on the surface of the magnetic recording medium according to another embodiment.

FIG. 22 is a view that illustrates an example of the steps of manufacturing a magnetic disk medium using nanoimprint lithography.

FIG. 23A to FIG. 23F are views that illustrate an example of the steps of creating a servo region formation stamper using self-organization.

### DESCRIPTION OF EMBODIMENTS

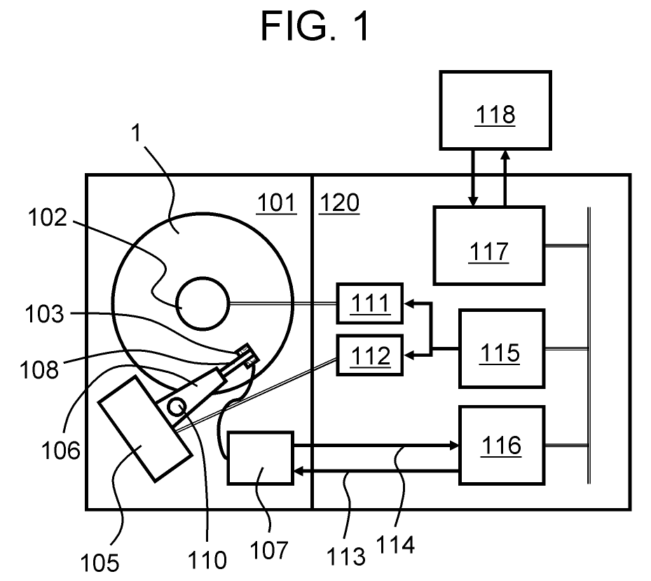

FIG. 1 is a schematic configuration diagram that illustrates an embodiment of a magnetic recording apparatus that is provided with a magnetic recording medium, which will be described later. The magnetic recording apparatus illustrated in FIG. 1 is provided with a disk-shaped magnetic recording medium (magnetic disk medium) 1 (hereinafter, the magnetic recording apparatus provided with the magnetic disk medium is called a magnetic disk apparatus). The magnetic disk apparatus includes a disk enclosure 101 and a circuit substrate 120.

The disk enclosure 101 is a case that hermetically mounts the magnetic disk medium 1, a spindle motor 102, a magnetic head 103, an actuator 105 that includes a voice coil motor (VCM) (not illustrated), a head gimbal assembly 108, a carriage arm 106, a shaft 110, a head amplifier 107, and the like. The magnetic disk medium 1 is attached to the spindle motor (SPM) 102. The magnetic head 103 includes at least one of a recording (write) element (not illustrated) that records magnetic information on the magnetic disk medium 1 or a reproducing (read) element (not illustrated) that has a function of extracting magnetic information recorded on the magnetic disk medium 1 as an electrical signal. The recording element, for example, includes a write coil, a main magnetic pole layer, and an auxiliary magnetic pole layer. The write coil has a function of generating magnetic flux. The main magnetic pole layer has a function of accommodating magnetic flux generated by the write coil and discharging the magnetic flux toward a magnetic disk. The auxiliary magnetic pole layer has a function of circulating magnetic flux discharged from the main magnetic pole layer via the magnetic disk. The reproducing element is, for example, an MR element (magnetoresistance element), or the like. The reproducing element is mounted on the head gimbal assembly 108, and is arranged so as to face the magnetic disk medium 1. The magnetic disk medium 1 may employ various types of magnetic recording medium, which will be described later. An end of the head gimbal assembly 108, at which the magnetic head 103 is not mounted, is fixed to the distal end of the carriage arm 106. The carriage arm 106 is able to be pivotally driven by the VCM with respect to the shaft 110 as a rotation axis. The magnetic head 103 is able to scan substantially radially over the magnetic disk medium 1 through the pivotal driving. The magnetic head 103 is positioned at a desired recording track on the magnetic disk medium 1, so that the magnetic head 103 is able to write information in recording bits arranged in the recording track on the magnetic disk medium 1 or read information from the magnetic disk medium 1. The head amplifier 107 performs recording on the magnetic medium 1 by causing electric current to flow through the recording element mounted on the magnetic head 103 on the basis of a recording signal 113 or converts magnetic information of the magnetic disk medium 1, detected by the reproducing element of the magnetic head 103, into a reproduced signal 114.

The circuit substrate 120 includes a read channel 116, a microprocessing unit (MPU) 115, a spindle motor (SPM) driver 111, a voice coil motor (VCM) driver 112, a disk controller 117, and the like. The read channel 116 decodes the reproduced signal 114 (servo signal or data signal) from the head amplifier 107 and converts the decoded signal into digital information or converts information that is specified for recording from the disk controller 117 into the recording signal 113 for driving the head amplifier 107.

The MPU 115 controls positioning of the magnetic head 103 by driving the VCM driver 112 on the basis of the digital information (servo information) of a servo signal decoded by the read channel 116 or controls rotation of the magnetic disk medium 1 by driving the SPM driver 111.

The disk controller 117 instructs the MPU 115 to position the magnetic head 103 on the basis of a recording/reproducing command from the host computer 118, and addresses the magnetic head 103 to the magnetic disk medium 1. In addition, the disk controller 117 transfers digital information to be recorded or reproduced with the read channel 116, and returns the result to the host computer 118.

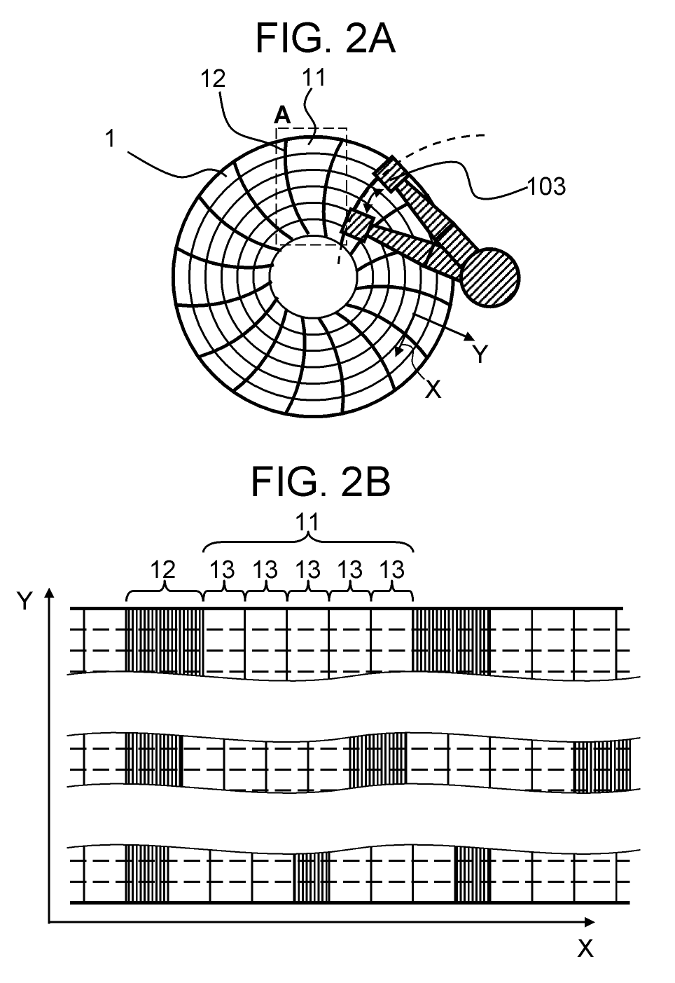

Hereinafter, embodiments of the magnetic recording medium will be described with reference to FIG. 2A to FIG. 21.

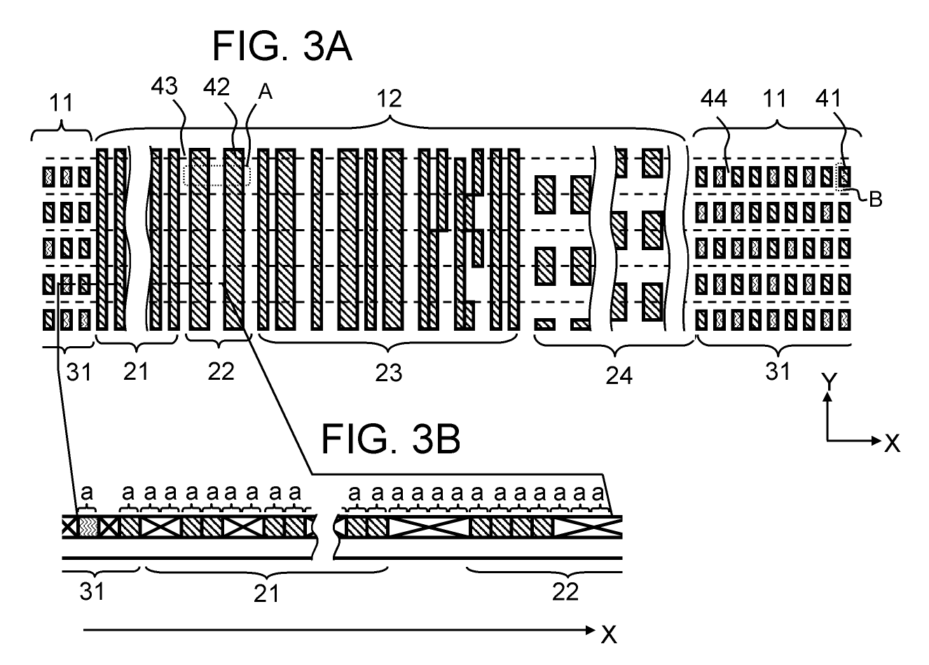

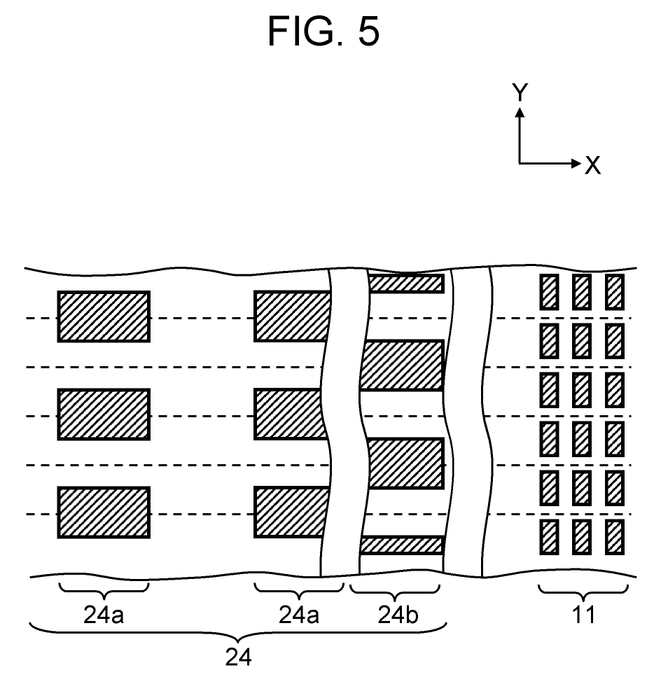

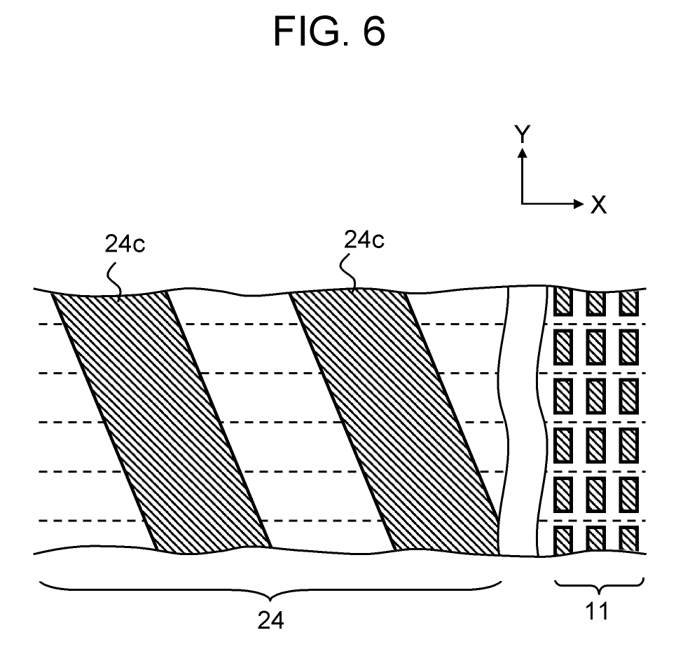

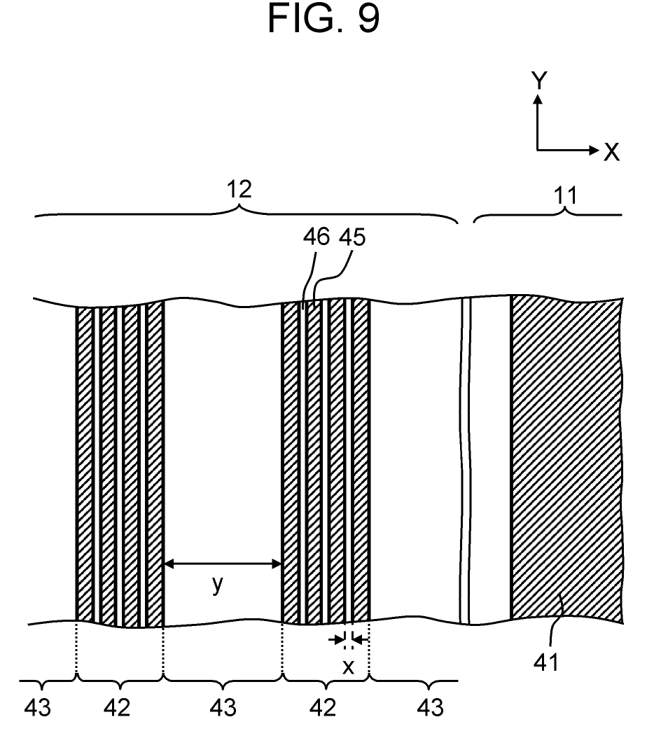

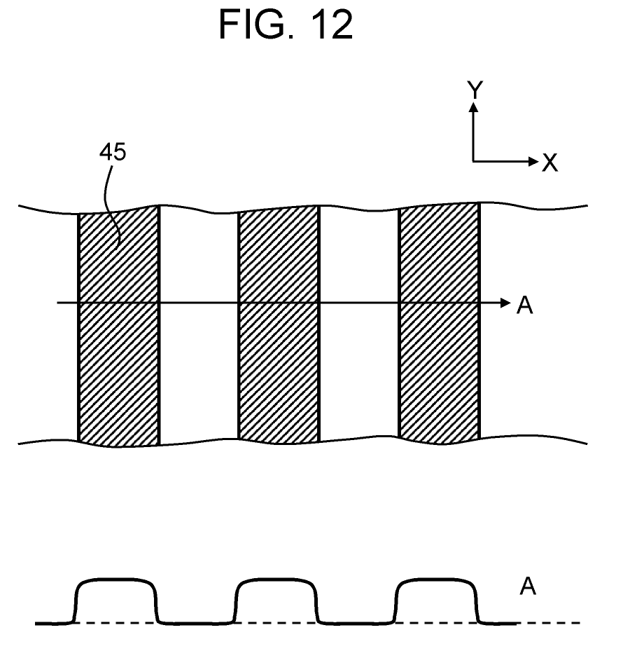

FIG. 2A is a conceptual plan view that illustrates a sector structure of the magnetic disk medium according to the embodiment, provided for the magnetic disk apparatus. FIG. 2B is an enlarged view of a portion A in FIG. 2A. Note that in the drawing, on the surface of the disk, the circumferential direction of the disk is set to X-axis, and the radial direction is set to Y-axis (hereinafter, the same applies to FIG. 3A, FIG. 3B, FIG. 5, FIG. 6, FIG. 9, FIG. 12 to FIG. 20).

Generally, on the magnetic disk medium 1, data regions 11 and servo regions 12 are arranged alternately in the circumferential direction. That is, the servo regions 12 are arranged intermittently on a substantially circumference having a belt-like shape with respect to substantially the center of the magnetic disk medium 1. In addition, the data regions 11 are arranged at portions on the substantially circumference of the belt-like shape, in which the servo regions 12 are not arranged.

The data regions 11 are areas in which data are stored. In each of the data regions 11, data sectors 13, which are storage areas used for recording and reproducing, are arranged at a constant track pitch in the circumferential direction. Each data sector 13 includes magnetic dots (not illustrated). The shape and arrangement of the magnetic portions provided in the data regions 11 are called a data pattern.

The servo regions (servo sectors) 12 are provided for specifying the positions (particularly, the positions in the radial direction of the disk) of the magnetic dots included in the data regions 11. Each servo region 12 includes magnetic segments that have various shapes, which will be described later, and that are arranged in various forms. The shape of each servo region 12 is formed in a circular arc shape that corresponds to a locus along which the head of the magnetic disk apparatus accesses and the length of the servo region in the circumferential direction increases in proportion to the radial position of the servo region. The shape and arrangement of magnetic segments provided in each servo region 12 are called a servo pattern.

The magnetic head 103 acquires the positional information of the magnetic head 103 by reading a reproduced signal formed by magnetic segments included in each servo region 12 while the magnetic disk medium is being rotated. On the basis of the acquired positional information of the magnetic head 103, the magnetic head 103 is positioned with respect to a track and, therefore, it is possible to perform recording and reproducing at a magnetic portion located at a desired position in the data region 11.

FIG. 3A is a schematic plan view that illustrates a surface of the magnetic disk medium according to the embodiment. FIG. 3B is a conceptual schematic view that illustrates a magnetized state of the data region and servo region. The magnetic recording medium of the present embodiment is a so-called patterned media in which the magnetic dots of the data regions and the magnetic segments of the servo regions are formed at predetermined positions.

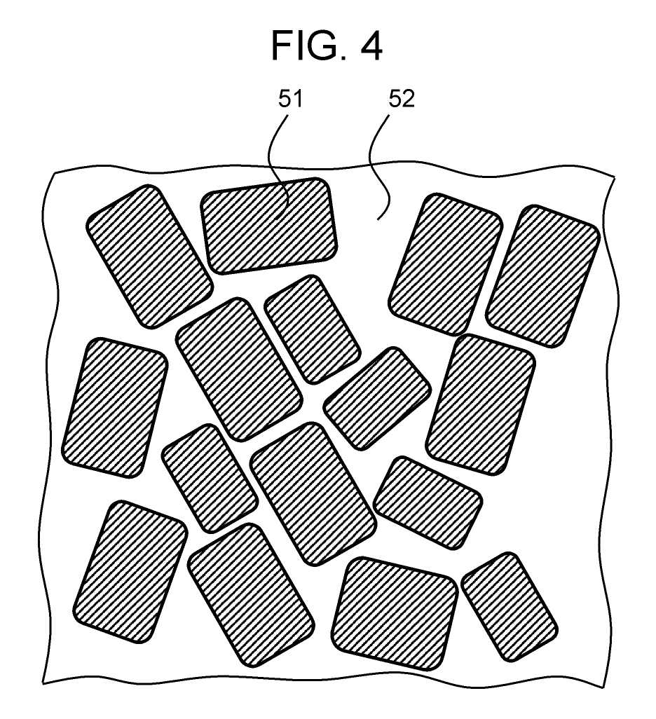

The plurality of magnetic dots 41 are arranged at predetermined positions in each data region 11. Inside the magnetic disk apparatus, the magnetic head scans over the magnetic dots 41 to form information dots a. Here, the arrangement at “predetermined positions” means that adjacent magnetic dots are arranged intermittently in accordance with a certain rule, that is, in the circumferential direction (track direction). Normally, the magnetic dots adjacent in the circumferential direction are arranged at constant intervals. The structure of magnetic dots formed by nanoimprint or photolithography, which will be described later, is an example of arrangement at predetermined positions. On the other hand, as illustrated in FIG. 4, a structure (so-called granular structure) in which the magnetic dots that are formed by dispersing the magnetic particles 51 in the nonmagnetic substance 52 are irregularly arranged is an example in which the magnetic dots are not arranged at predetermined positions. The magnetic dots 41 are, for example, formed of polycrystal of a ferromagnetic substance, such as CoCrPt. A nonmagnetic substance 44, such as silica, alumina, or air, is arranged around the magnetic dots 41. The nonmagnetic substance 44 separates any adjacent two magnetic dots 41. In the magnetic disk apparatus, the magnetic dots 41 each are applied with a desired magnetic field by the recording element. Owing to the magnetic field, magnetization of the magnetic dots 41 is held in a state where it is oriented in a desired direction. In this manner, the magnetic dots 41 are able to store magnetic information. In addition, the reproducing element reproduces magnetic information recorded in the magnetic dots. Note that in FIG. 3A, the magnetic dots 41 are indicated by different hatchings according to the direction of magnetization. In addition, in the vertical magnetic recording magnetic disk medium, magnetization of the magnetic dots is oriented in the normal direction to the surface of the medium.

Each servo region 12 includes a magnetic portion 42 and a nonmagnetic portion 43. The magnetic portion 42 includes a plurality of magnetic segments (not illustrated) and a nonmagnetic substance (not illustrated) that is arranged so as to surround the magnetic segments. The magnetic segments and the nonmagnetic substance will be described later. Note that in the patterned media, normally, magnetization of the each magnetic segment is oriented in the same direction. The nonmagnetic portion 43 is made of a nonmagnetic substance. Inside the magnetic disk apparatus, the magnetic head scans over the magnetic portion 42 and the nonmagnetic portion 43 to thereby form information bits “a” based on magnetism or non-magnetism.

In FIG. 3A, servo patterns have either of bit 0 region formed by the nonmagnetic portion 43 and bit 1 region formed by the magnetic portion 42 in the servo region 12. Each of the bit 1 regions 42 is formed by a plurality of magnetic segments which are separate from each other at least along each track. Actual segment patterns are not illustrated in FIG. 3A. Actual dimension relation between the magnetic segments within magnetic portion 42 and the magnetic dots 41 should be understood from FIG. 9.

Each servo region 12 may be classified by the function used in the magnetic disk medium into a synchronization signal generating portion 21, a synchronization signal detecting portion 22, an address portion 23, and a fine position detecting portion 24.

The synchronization signal generating portion 21 has a function of adjusting the amplification factor of a signal amplification to keep the amplitude constant before calling servo information and a function of generating a sampling timing of an A/D conversion (Analog to Digital Converter) clock signal. The synchronization signal generating portion 21 includes magnetic portions that are radially continuous all over the range from the inner periphery of the medium to the outer periphery thereof or portion of the range and that are circumferentially formed at constant intervals.

The synchronization signal detecting portion 22 is a characteristic pattern that indicates the start of the servo information. The synchronization signal detecting portion 22 includes a single magnetic portion that is radially continuous all over the range from the inner periphery of the medium to the outer periphery thereof or portion of the range and has a bit length that is circumferentially longer than the synchronization signal generating portion or includes a plurality of magnetic portions that generate a default code having a few or several bit length.

The address portion 23 is an ID pattern that indicates a track number and a sector number of each servo frame. In the magnetic recording apparatus, the address portion 23 indicates a track position at which the magnetic head is located. The address portion 23 includes a magnetic substance that are radially continuous at the position in the circumferential direction indicating a sector number all over the range from the inner periphery of the medium to the outer periphery thereof or portion of the range, a material that are radially continuous at the position in the circumferential direction indicating the high order digit of a track number all over the range from the inner periphery of the medium to the outer periphery thereof or portion of the range, and a magnetic substance that is intermittent in the radial direction of medium at the position in the circumferential direction indicating the low order digit of the track number.

The fine position detecting portion 24 is provided for the magnetic recording apparatus in order to detect information indicating a deviation in position of the magnetic head from the center of the track. One example of the fine position detecting portion 24 is that one or two types of magnetic patterns formed of a specific shape and arrangement in the circumferential direction are provided, and each magnetic pattern is arranged in each track at equal intervals in the radial direction of the medium (for example, as in the case of the position detection portions 24a and 24b illustrated in FIG. 5). In addition, another example of the fine position detecting portion 24 is that a belt-like magnetic pattern (hereinafter, termed oblique belt-like magnetic pattern), whose longitudinal direction is not parallel to the radial direction of the disk, extends over a plurality of tracks (for example, as in the case of the fine position detecting portions 24c illustrated in FIG. 6).

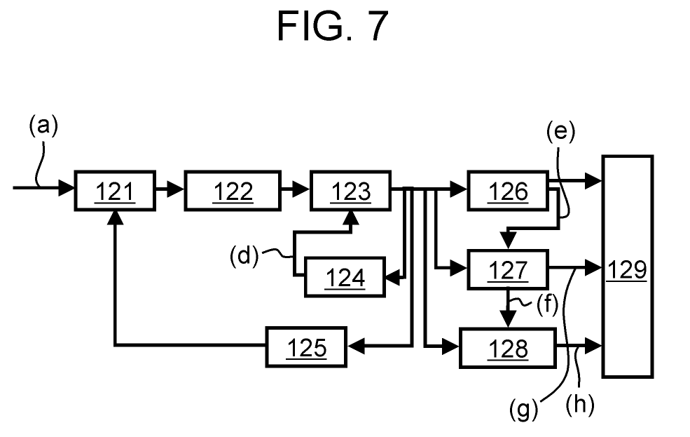

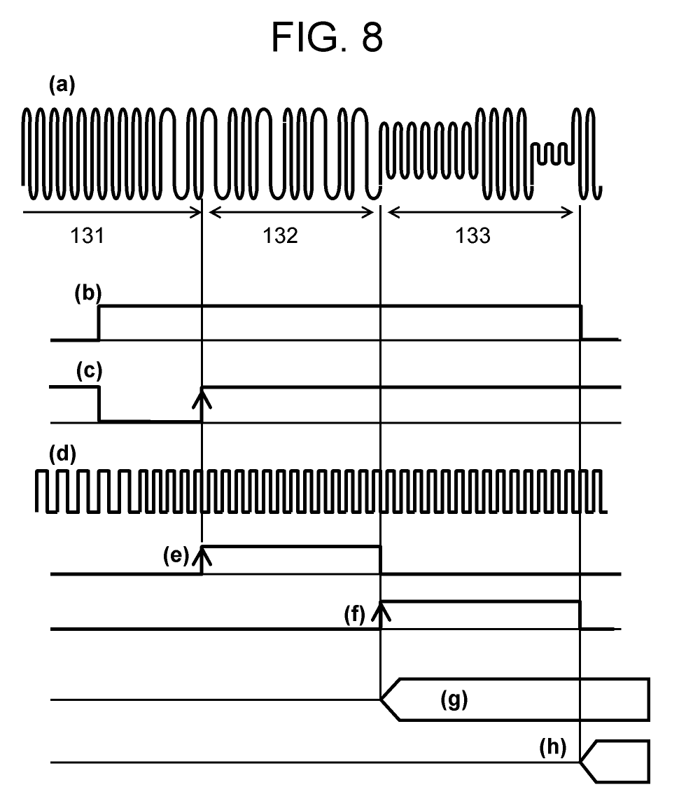

FIG. 7 is a block diagram that illustrates, in the magnetic recording apparatus that is provided with the magnetic disk medium of the present embodiment, the operation of the read channel 116 at the time when servo information on the magnetic disk medium is read when the MPU executes positioning control of the magnetic head. FIG. 8 is a time chart of the operation of the read channel.

Because the magnetic disk medium 1 rotates at a constant angular velocity, a servo pattern reproduced signal (a) may be acquired at constant time intervals from the head amplifier. The servo pattern reproduced signal (a) is processed in the read channel 116 by a low-pass filter 122 to block a high frequency noise component, A/D conversion is performed by an A/D converter 123, and then a variable gain 121 is adjusted by a gain controller 125 on the basis of digitized amplitude information so as to acquire an optimal amplitude.

The introducing portion of the servo pattern has a pattern of a constant period, which is written as the synchronization signal generating portion 21, and is configured so that a servo gate signal (b) is asserted in advance so as to obtain a sufficient number of waves to allow a phase lock loop (PLL) circuit 124 to converge.

As the servo gate signal (b) is asserted, the synchronization signal of the servo pattern reproduced signal is performed with PLL, and then an ADC clock signal (d) necessary for sampling the address portion and the fine position detecting portion that appear in the servo pattern reproduced signal is generated from the PLL circuit 124.

A servo sync mark pattern that indicates the start of servo information is written in bits of a constant length or in specific code pattern bits at the end of the synchronization signal generating portion of the servo pattern. As the servo sync mark pattern is detected, the synchronization pattern detection signal (c) is asserted.

A synchronization signal detector 126 confirms assertion of the synchronization pattern detection signal (c), transmits an address detection gate signal (e) to an address demodulator 127 to thereby demodulate the address portion to be reproduced.

As the demodulation of the address portion having a default length ends, an address demodulated value (g) is fixed and is recorded in a register 129 as digital information. In addition, a burst gate signal (f) is subsequently asserted, and demodulation of the fine position detecting portion is started by a fine position demodulator 128.

As the demodulation of the fine position detecting portion having a default length ends, a fine position demodulated value (h) is fixed and is recorded in the register 129 as digital information.

Through the above operations, the MPU 115 reads the address demodulated value (g) and fine position demodulated value (h) stored in the register, performs computing necessary for positioning control of the magnetic head, and then drives the VCM driver 112.

FIG. 9 is an enlarged schematic view of the synchronization signal generating portion within the servo region of the magnetic recording medium according to the present embodiment illustrated in FIG. 3. A dotted line region A of the synchronization signal detecting portion 22 and a dotted line region B of the magnetic dots 41 in FIG. 3 is illustrated in FIG. 9. The servo region 12 includes a collecting portion of magnetic segments 45, that is, the magnetic portion 42 of the servo region 12, for specifying the radial position of the magnetic dot 41 included in the data region 11. The servo region 12 further includes the nonmagnetic portion 43.

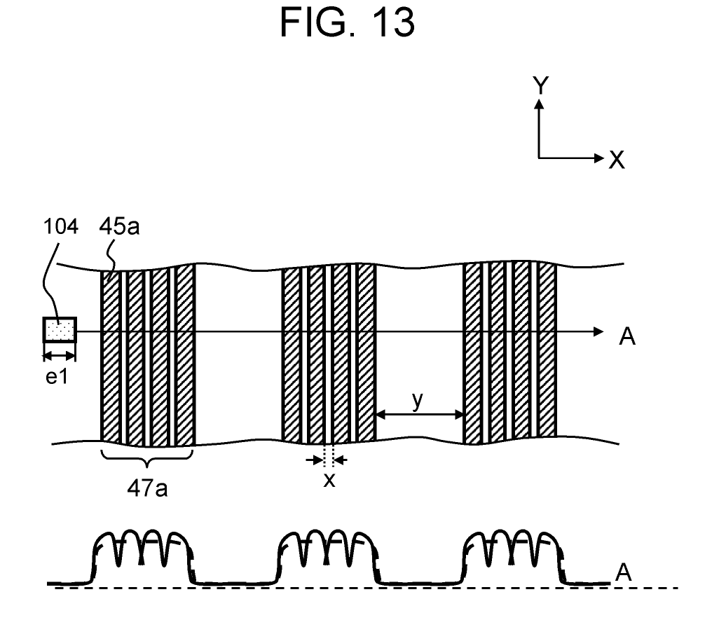

Each magnetic portion 42 is formed so that the magnetic segments 45 that are smaller than the magnetic dots 41 are arranged at predetermined positions. The magnetic segments 45 are isolated from each other. Each of the magnetic segments 45 can have a dot-like shape or stripe-like shape as illustrated in FIG. 9, FIG. 13 to FIG. 21. Each magnetic segment 45 has a rectangular shape; however, the shape of the magnetic segment according to the aspects of the invention is not specifically limited, and it may be various shapes, such as circular shape, elliptical shape, or polygonal shape, as needed. In addition, in FIG. 9, the size of the magnetic dot and the size of the magnetic segment are not limited as shown in the drawing. Here, the arrangement at “predetermined positions” means that adjacent magnetic dots are arranged in accordance with a certain rule. The certain rule may be changed in accordance with application of the magnetic recording medium. A so-called patterned media is an example in which magnetic segments are arranged at predetermined positions. The structure of magnetic segments formed by nanoimprint or photolithography, which will be described later, is an example of arrangement at predetermined positions. On the other hand, the structure (so-called granular structure) in which the magnetic dots that are formed by dispersing the magnetic substance in the nonmagnetic substance are irregularly arranged, as illustrated in FIG. 4, is an example in which the magnetic dots are not arranged at predetermined positions. The magnetic segments are, for example, formed of polycrystal of a ferromagnetic substance, such as CoCrPt. A nonmagnetic substance 46 made of a nonmagnetic material, such as silica, alumina, or air, is arranged around the magnetic segments. That is, the nonmagnetic substance 46 separates any adjacent magnetic segments 45. In addition, the nonmagnetic portion 43 is made of a nonmagnetic material, such as silica, alumina, or air.

In the magnetic recording medium of the present embodiment, each of the magnetic segments arranged has a smaller dimension in at least one direction than each of the magnetic dots. Each of the magnetic segment preferably has a smaller area than each of the magnetic dot. When the relationship between the magnetic dot and the magnetic segment is as described above, the following function may be obtained.

The magnetic segments generate magnetization in a single direction, necessary for specifying servo information, by normally applying a strong magnetic field to the entire medium before the magnetic recording medium is used. However, because the magnetic segment having an area larger than the magnetic dot has a low coercive force, as in the case of the existing synchronization signal generating portion, even when an external magnetic field that enables all the magnetic segments to be magnetized in a signal direction is applied, portion of magnetization is inverted and, therefore, it has been difficult to maintain a stable servo pattern.

In order to obtain a magnetic recording medium that provides a highly reliable reproduced signal of the servo region, the inventors have focused on the ratio of the area of magnetic portion in a servo region to the area of magnetic dot in a data region in the existing patterned media. In a typical magnetic disk apparatus, the magnetic disk medium is rotated so that a rotational angular velocity is constant. The magnetic disk medium that rotates as in the above described manner is designed so that the amount of information recorded in the servo regions 12 in one complete circle is equal between an inner peripheral portion and an outer peripheral portion. Thus, in the servo regions 12, the length in the circumferential direction of the magnetic portion 42 that constitutes one bit servo information is long at the outer peripheral portion of the disk and short at the inner peripheral portion of the disk. In contrast, the length in the circumferential direction of one bit data information in each data sector 13 that constitutes the data region 11 is substantially equal between the inner peripheral portion of the disk and the outer peripheral portion of the disk in order to keep the data recording density substantially constant on the surface of the disk. Thus, a remarkable difference in length in the circumferential direction between a magnetic portion 42 in the servo region and a magnetic dot 41 in the data region appears particularly at the outer peripheral portion of the disk. In addition, the data region includes independent magnetic dots 41 that are intermittently arranged both in the circumferential direction of the disk and in the radial direction of the disk. On the other hand, the servo region 12, specifically, the synchronization signal generating portion 22, includes magnetic portion that are continuous in the radial direction of the disk. For this reason, a difference in length in the radial direction between a magnetic portion 42 in the servo region and a magnetic dot 41 in the data region also largely influences the ratio of the areas of them.

For example, when a 2.5-inch magnetic disk medium in 130 Gbpsi (130 gigabits per square inch) class is designed so as to have a track density of 140 kTPI (140 thousand tracks per inch) and a bit density of 950 kBPI (950 kilobits per inch), the size of a data sector at this time is a track width of 177 nm and a bit length of 26.1 nm. When the above disk is driven at a speed of 5400 rpm, the linear speed is about 17 m/s at a position of the radius 30 mm which corresponds to the outermost periphery of the disk. The servo frequency is a frequency when the servo pattern reproduced signal acquired from a reproducing head is sampled by A/D conversion. Here, when it is configured so that the servo frequency is 140 Mbps (140 megabits per second) and one bit has a length of two samples, the overall length in the circumferential direction of the servo pattern formed by 500 bits is about 0.116 mm. That is, the one bit length of the servo pattern is 231 nm, and it appears that the one bit length is about nine times the length of the data bit.

In addition, particularly, the servo sectors of the synchronization signal generating portion and synchronization signal detecting portion within the servo pattern are normally formed continuously in the radial direction of the disk, so that the size in the track width direction will be about six digits larger at the maximum.

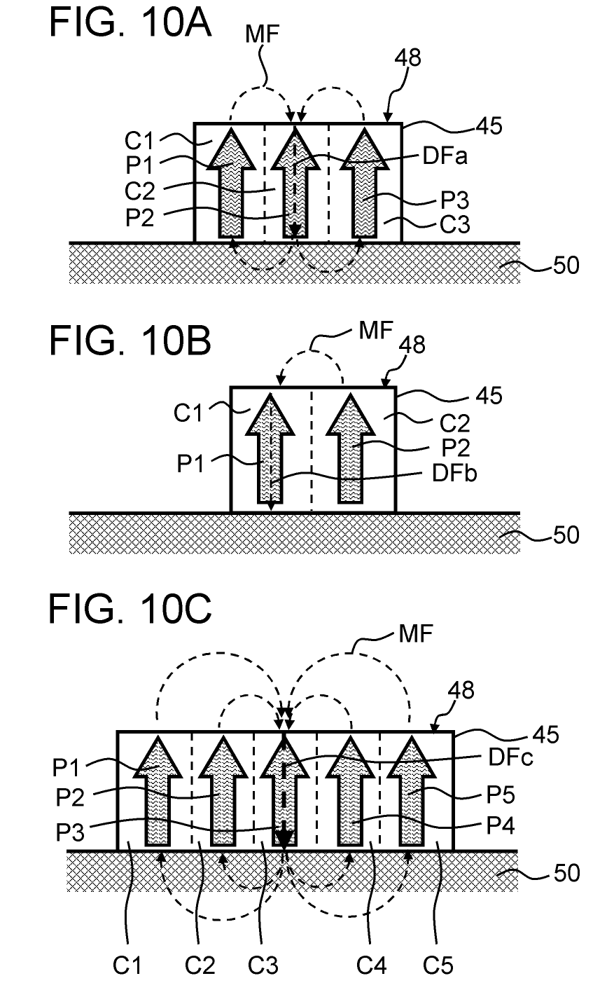

FIG. 10A to FIG. 10C are schematic views that illustrate the relationship between the size of an area of a magnetic segment 45, provided on the substrate 50, and magnetization and demagnetizing field generated from the magnetic segment 45. The magnetic segment 45 is formed of a crystal particle and is, normally, a polycrystal. In a polycrystal, a plurality of crystalline regions separated by grain boundary have an exchange coupling force applied between the regions. Thus, the crystalline regions in each magnetic segment are normally magnetized in a single direction. Note that in FIG. 10A to FIG. 10C, for the sake of convenience, all the crystalline regions occupy the same volume. In addition, the magnetic segment area means an area of an upper surface 48 of the magnetic segment 45.

In FIG. 10A, the magnetic segment 45 is formed of three crystalline regions C1 to C3. The crystalline regions respectively generate magnetizations P1 to P3. In the crystalline region C2, a magnetic field MF generated from the right and left crystalline regions are applied in addition to the demagnetizing field of the crystalline region C2 due to magnetization by itself to thereby increase a demagnetizing field DFa.

In FIG. 10B, the magnetic segment 45 is formed of two crystalline regions C1 and C2. Magnetizations P1 and P2 are respectively generated in the crystalline regions. In the crystalline region C2, a magnetic field MF generated from the crystalline region C1 is applied. In FIG. 10B, because the area of the magnetic segment is smaller than that of FIG. 10A, the magnetic field MF is also smaller than that of FIG. 10A. Thus, a demagnetizing field DFb generated in the crystalline region C2 is smaller than the demagnetizing field DFa. Thus, a relatively small magnetic segment is less likely to generate a demagnetizing field in the crystalline regions and, therefore, has a large coercive force.

In FIG. 10C, the magnetic segment 45 is formed of five crystalline regions C1 to C5. Magnetizations P1 to P5 are respectively generated in the crystalline regions. In the crystalline region C3, a magnetic field MF generated from the crystalline regions C1, C2, C4 and C5 is applied. In FIG. 10C, the area of the magnetic segment is larger than that of FIG. 10A, and the magnetic field MF is also larger than that of FIG. 10A. Thus, a demagnetizing field DFc generated in the crystalline region C3 is larger than the demagnetizing field DFa. The magnetic segment having a relatively large area is more likely to generate a demagnetizing field in the crystalline region and, therefore, has a small coercive force. As described above, as the area of the magnetic segment increases, the coercive force tends to reduce.

When the magnetic segments are used in the magnetic recording apparatus, because the area of each magnetic segment is smaller than that of the magnetic dot, the orientation of magnetization of the magnetic segment that is once magnetized in a single direction is less likely to be changed. Thus, the above magnetic recording medium has high reliability in reproduced signal of the servo region.

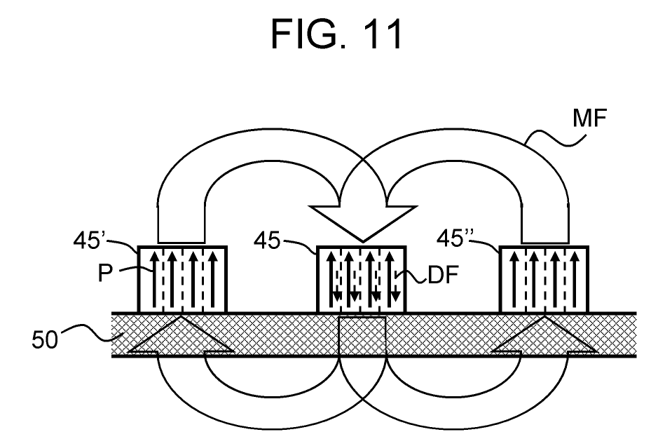

In addition, in comparison with the existing magnetic recording medium having a magnetic portion in granular structure, the patterned media tends to have a less coercive force of the magnetic segment in the servo regions. FIG. 11 is a conceptual view that illustrates the relationship between magnetization and demagnetizing field generated from a plurality of magnetic segments on the surface of the magnetic recording medium according to the present embodiment. When the patterned media, such as the magnetic recording medium according to the present embodiment, is used in the magnetic recording apparatus, particularly, all the magnetic segments in the servo regions normally have magnetizations P in the same direction as illustrated in FIG. 11. The middle magnetic segment 45 is applied with a magnetic field MF from the left and right magnetic segments 45′ and 45″, so that a demagnetizing field DF increases. Thus, the magnetic segments in the servo regions of the patterned media tend to have less coercive force. Hence, in the patterned media, in order to increase the coercive force of the magnetic segments in the servo region, it is effective that the area of each magnetic segment is set to be smaller than the area of the magnetic dot.

In terms of simplification of process, the magnetic dots and the magnetic segments are preferably formed in the same process using the same material. In this case, if a magnetic material having a large coercive force is selected as the material of the magnetic segments, the magnetic dots are also made of a magnetic material having a large coercive force. At this time, there is a possibility that the magnetic head cannot record information to the magnetic dots in the data region because of an excessively large coercive force of the magnetic dots. According to the magnetic recording medium of the present embodiment, because the above problem does not occur, so that high reliability in recording and reproducing for the data region is ensured.

Referring back to FIG. 9, the magnetic disk medium of the present embodiment will be described. In the servo region 12, the length of the nonmagnetic portion 43 in the circumferential direction is larger than the gap (x in FIG. 9) between any two adjacent magnetic segments 45. By arranging the magnetic portions 42 and the nonmagnetic portions 43 in this manner, when the magnetic recording medium of the present embodiment is mounted and used in the magnetic recording apparatus, it is easy for the magnetic head to identify a reproduced signal generated by the nonmagnetic portion 43 and the magnetic portion 42.

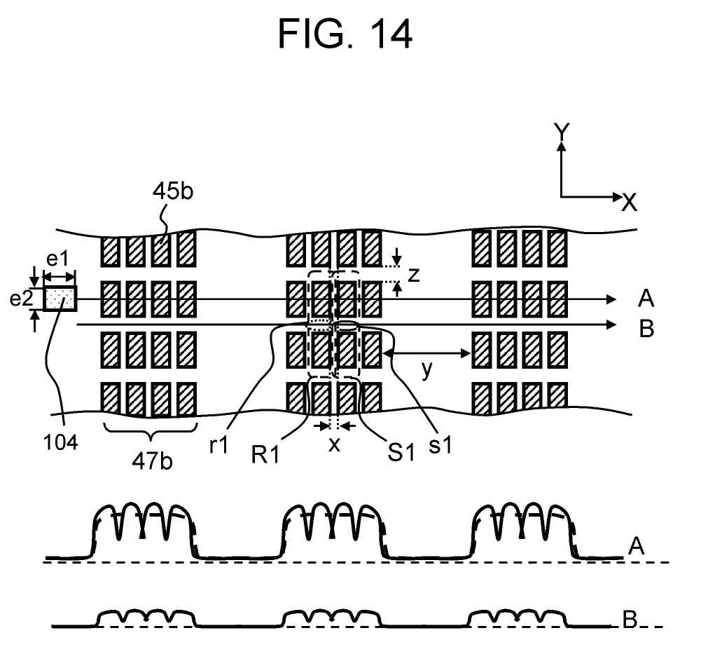

FIG. 12 to FIG. 19 are enlarged schematic views (at the top) of the synchronization signal generating portion in the servo region of the magnetic recording medium and are reproduced signal waveforms (at the bottom) when the magnetic head passes over the above area. Note that the abscissa axis of the reproduced signal waveform represents a position of the magnetic disk medium in the circumferential direction, and the ordinate axis represents strength of the reproduced signal. Arrows A to C in the circumferential direction in the drawings indicate positions along which the magnetic head passes, and correspond to the reproduced signal waveforms A to C in the drawing at the bottom, respectively. An element included in the magnetic head, for writing or reading magnetic information on or from a magnetic recording medium is also illustrated in FIG. 13 and FIG. 14. In addition, the size of each magnetic dot and the size of each magnetic segment are not limited as illustrated in the drawings.

FIG. 12 is a schematic view that illustrates a servo pattern having the existing synchronization signal generating portion as a comparative embodiment. When the magnetic head passes over the magnetic segments 45, a desired reproduced signal is generated. However, the magnetic segments that are long in the radial direction of the medium may possibly have insufficient coercive force.

FIG. 13 is a schematic view that illustrates a synchronization signal generating portion on the surface of the magnetic recording medium according to the present embodiment. Note that the waveform of the dotted line reproduced signal is a waveform after the solid line original reproduced signal has passed a low-pass filter (hereinafter, the same applies to FIG. 14 to FIG. 19). As described above, because the area of each magnetic segment 45a is smaller than that of the magnetic dot 41 (not illustrated), the magnetic segment 45a has a large coercive force. In addition, the synchronization signal generating portion includes collecting portions 47a of the magnetic segments 45a as the magnetic portions. The gap x between any pair of magnetic segments adjacent in the circumferential direction in each collecting portion 47a is smaller than the gap y between the collecting portions, which are adjacent in the circumferential direction, of the magnetic segments. Because of the small gap x, the waveform that the reproduced signal has passed through the low-pass filter does not illustrate an extreme decrease in strength as compared with the waveform of the reproduced signal illustrated in FIG. 12. The allowable ranges of x and y vary depending on the disk revolving velocity, the frequency of servo sampling, the characteristics of the low-pass filter, and the like, during usage, and normally, the gap x is preferably tenth the gap y or smaller in terms of reliability of a reproduced signal. For example, the magnetic segments may be arranged so that the gap x is 20 nm and the gap y is 200 nm.

When used in the magnetic recording apparatus, the gap x between the plurality of magnetic segments adjacent in the circumferential direction is preferably shorter than the length e1 of the element 104 of the magnetic head 103 in terms that a decrease in strength of the reproduced signal that has passed the low-pass filter is further small. The length e1 is in the circumferential direction of the magnetic disk medium. Particularly, the gap x is preferably 40% or below the length of the element of the magnetic head 103.

FIG. 14 is a schematic view that illustrates a synchronization signal generating portion on the surface of the magnetic recording medium according to another embodiment. Because the area of each magnetic segment 45b is by far smaller than that of the magnetic dot 41 (not illustrated), the magnetic segment 45b has an extremely large coercive force. In addition, the synchronization signal generating portion includes collecting portions 47b of the magnetic segments 45b, and the gap between the magnetic dots adjacent in the circumferential direction in each collecting portion 47b and the gap z between the magnetic dots adjacent in the radial direction are smaller than the gap y between the collecting portions, which are adjacent in the circumferential direction, of the magnetic segments. Because of the gaps x and z smaller than the gap y, the waveform that the reproduced signal has passed through the low-pass filter does not illustrate an extreme decrease in strength as compared with the waveform of the reproduced signal illustrated in FIG. 12. However, in FIG. 14, the gap r1 between a pair of magnetic segments (R1 in FIG. 14) adjacent in the radial direction in the collecting portion 47 of the magnetic segment 45 and the gap s1 between another pair of magnetic segments (S1 in FIG. 14), which are located adjacent in the circumferential direction to the above pair of magnetic segments, are positioned at the same distance from the center of the magnetic recording medium. In comparison with the reproduced signal when the magnetic head passes along the locus of A in FIG. 14, the reproduced signal when the magnetic head passes along the locus of B in FIG. 14 may possibly decrease in signal amplitude.

When used in the magnetic recording apparatus, the gap x between the plurality of magnetic segments adjacent in the circumferential direction is preferably shorter than the length e1 of the element 104 of the magnetic head 103, and the gap z between the plurality of magnetic segments adjacent in the radial direction is preferably shorter than the width e2 of the element of the magnetic head 103, in terms that a decrease in strength of the reproduced signal that has passed the low-pass filter is further small. The length e1 is in the circumferential direction on the magnetic recording medium. The width e2 is in the track width direction, that is, in the radial direction on the magnetic recording medium. Particularly, the gap z is preferably 40% or below the width of the element of the magnetic head 103.

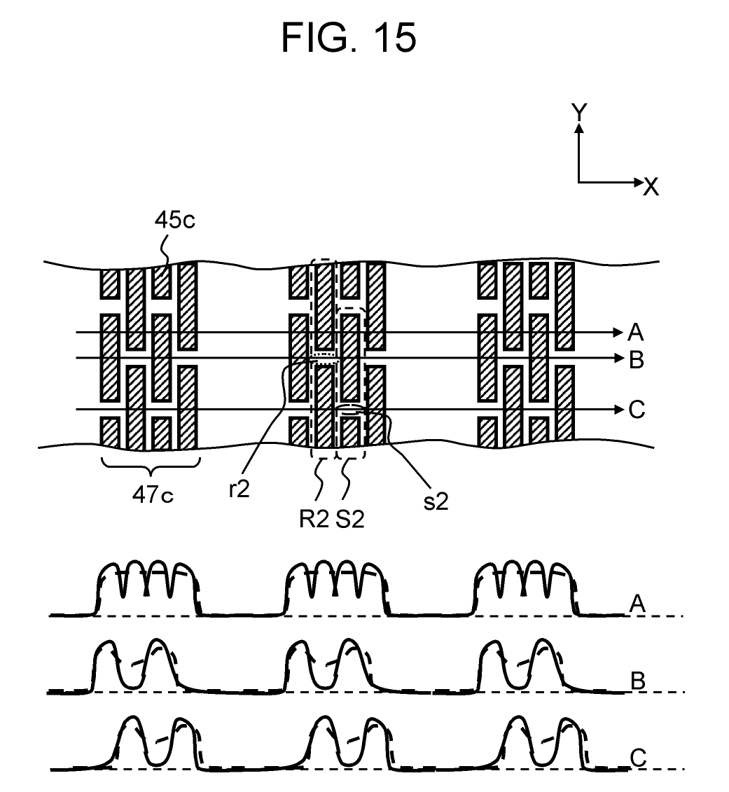

FIG. 15 is a schematic view that illustrates a synchronization signal generating portion on the surface of the magnetic recording medium according to another embodiment. The gap r2 between a pair of magnetic segments (R2 in FIG. 15) adjacent in the radial direction in the collecting portion 47c of the magnetic segments 45c and the gap s2 between another pair of magnetic segments (S2 in FIG. 15), which are located adjacent in the circumferential direction to the above pair of magnetic segments, are positioned at the same distance from the center of the magnetic recording medium. The above magnetic recording medium is preferable in terms that, even when the magnetic head passes along any loci over the magnetic recording medium, the signal amplitude of the reproduced signal after passing through the filter is substantially equal. However, depending on the locus along which the magnetic head passes, jitter of the reproduced signal may arise.

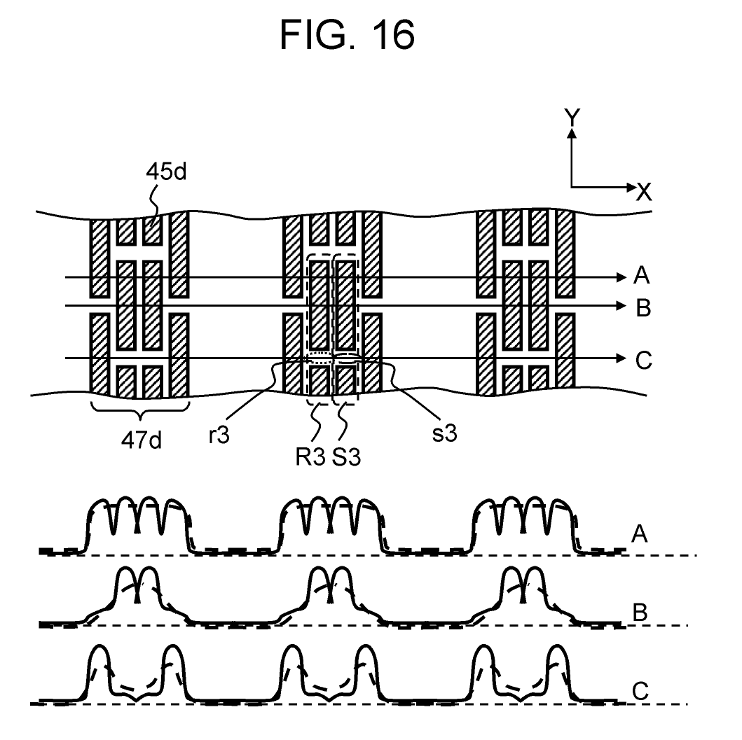

FIG. 16 is a schematic view that illustrates a synchronization signal generating portion on the magnetic recording medium according to another embodiment. In each collecting portion 47d of the magnetic segments 45d, the plurality of magnetic segments are arranged symmetrically with respect to a straight line that passes through the substantially center of the magnetic disk medium. The above magnetic recording medium is preferable in terms that jitter of the reproduced signal hardly arise depending on the locus along which the magnetic head passes as illustrated in FIG. 16. However, as in the case of FIG. 14, the gap r3 between a pair of magnetic segments (R3 in FIG. 16) adjacent in the radial direction in the collecting portion 47d of the magnetic segments 45d and the gap s3 between another pair of magnetic segments (S3 in FIG. 16), which are located adjacent in the circumferential direction to the above pair of magnetic segments, are positioned at the same distance from the center of the magnetic recording medium. Depending on the locus along which the magnetic head passes, the signal amplitude may excessively decrease.

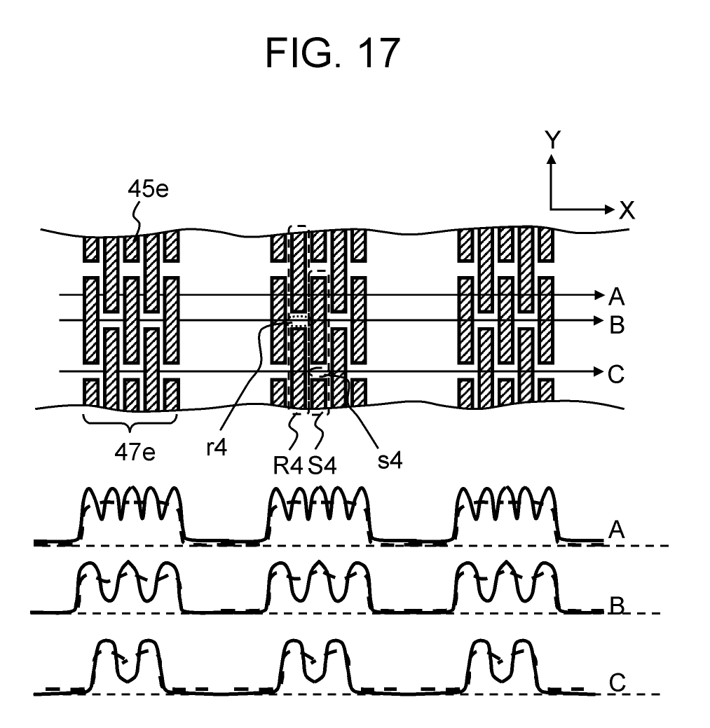

FIG. 17 is a schematic view that illustrates a synchronization signal generating portion on the surface of the magnetic recording medium according to another embodiment. As in the case of FIG. 15, the gap r4 between a pair of magnetic segments (R4 in FIG. 17) adjacent in the radial direction in the collecting portion 47e of the magnetic segments 45e and the gap s4 between another pair of magnetic segments (S4 in FIG. 17), which are located adjacent in the circumferential direction to the above pair of magnetic segments, are positioned at the same distance from the center of the magnetic recording medium. The above magnetic recording medium is preferable in terms that, even when the magnetic head passes any loci on the magnetic recording medium, the signal amplitude of the reproduced signal after passing through the filter is substantially equal. In addition, as in the case of FIG. 16, in each collecting portion 47e of the magnetic segments 45e, the plurality of magnetic segments 45e are arranged symmetrically with respect to a straight line that passes through the substantially center of the magnetic disk medium. The above magnetic recording medium is preferable in terms that jitter of the reproduced signal hardly arise depending on the locus along which the magnetic head passes.

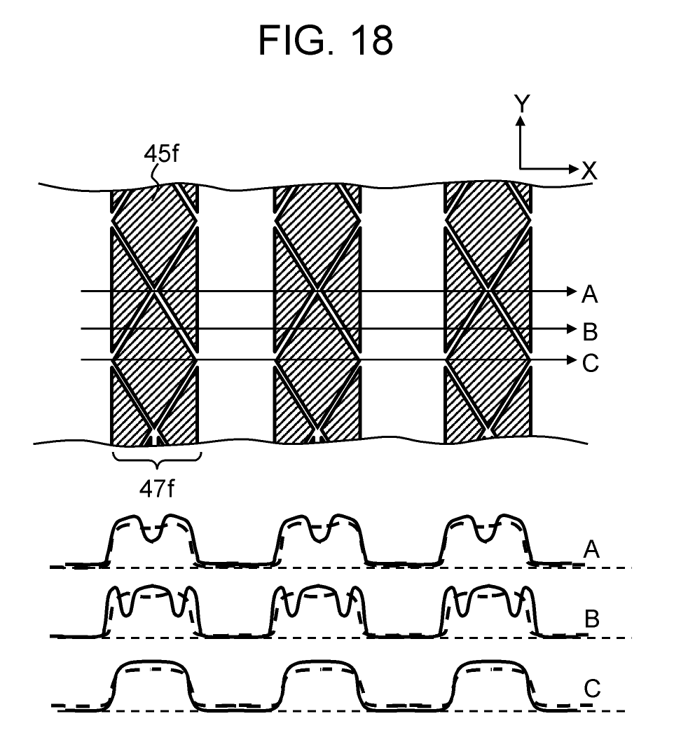

FIG. 18 is a schematic view that illustrates a synchronization signal generating portion on the surface of the magnetic recording medium according to another embodiment. Magnetic segments 45f respectively have shapes such that the magnetic segments 45a illustrated in FIG. 12 are separated by an X-shaped nonmagnetic substance over the circumferential direction of the medium. As in the case of FIG. 16, in each collecting portion 47f of the magnetic segments 45f, the plurality of magnetic segments are arranged symmetrically with respect to a straight line that passes through the substantially center of the magnetic disk medium. The above magnetic recording medium is preferable in terms that jitter of the reproduced signal hardly arise depending on the locus along which the magnetic head passes.

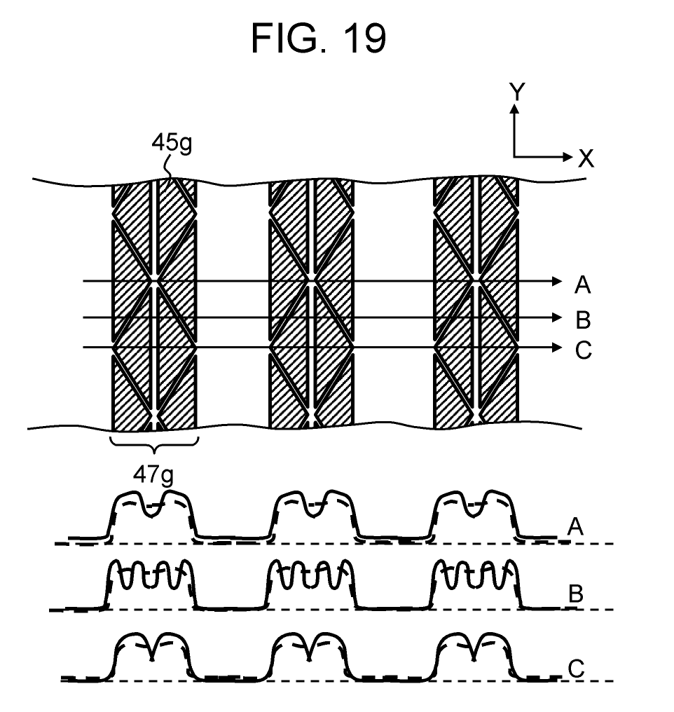

FIG. 19 is a schematic view that illustrates a synchronization signal generating portion on the surface of the magnetic recording medium according to another embodiment. Magnetic segments 45g respectively have shapes such that the magnetic segments 45a illustrated in FIG. 12 are separated by an X-shaped nonmagnetic substance over the circumferential direction of the medium and separated by a straight line that passes through the substantially center of the magnetic disk medium. As in the case of FIG. 16, in each collecting portion 47g of the magnetic segments 45g, the plurality of magnetic segments are arranged symmetrically with respect to a straight line that passes through the substantially center of the magnetic disk medium. The above magnetic recording medium is preferable in terms that jitter of the reproduced signal hardly arise depending on the locus along which the magnetic head passes. In addition, the magnetic segments 45g are preferable in terms that each magnetic segment 45g is smaller than the magnetic segment 45f illustrated in FIG. 18 and has a large coercive force.

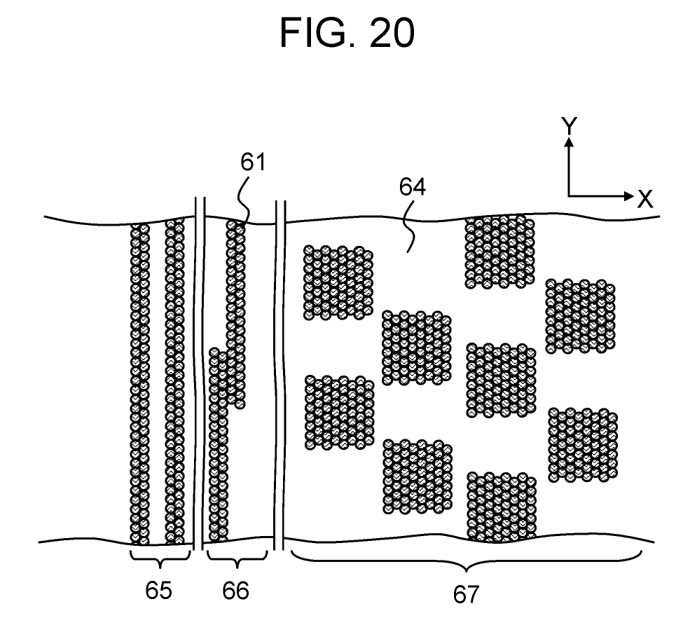

FIG. 20 is a schematic view that illustrates the servo region on the surface of the magnetic recording medium according to another embodiment. The servo region is formed of a synchronization signal generating portion 65, an address portion 66, a fine position detecting portion 67, and a nonmagnetic substance 64 in which no magnetic segment is present. The synchronization signal generating portion 65, address portion 66 and fine position detecting portion 67 each include magnetic segments 61 that are arranged in a hexagonal lattice. The above arrangement of the magnetic segments 61 may be formed by self-organization, which will be described later, by which a recording material is created using a self-organizing material, such as a diblock polymer or fine particles. The size of each magnetic segment 61 depends on the crystallinity of the self-organizing material, so that selection of a material enables control of the size of each magnetic segment 61.

Magnetic segments that are arranged through self-organization are advantageous in order to form fine magnetic segments. The magnetic segments that are arranged through self-organization may be located at positions deviated from a collecting portion of the magnetic segments having a desired size or may be different in size from the collecting portion. However, when the servo pattern is formed using fine magnetic segments, it is possible to acquire a sufficiently accurate reproduced signal even in the above cases.

The magnetic recording medium according to the present embodiment is thus described by taking the synchronization signal generating portion, for example. As in the case of the above, the synchronization signal detecting portion, the address portion, and the fine position detecting portion may obtain the advantageous effects of the aspects of the invention by arranging the above described magnetic segments.

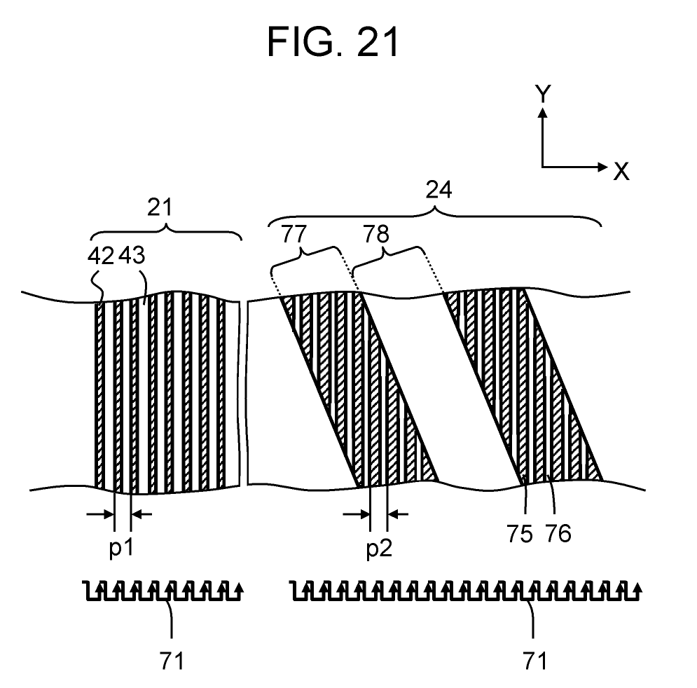

FIG. 21 is a schematic view that illustrates a fine position detecting portion and a synchronization signal generating portion on the surface of the magnetic recording medium according to another embodiment. The fine position detecting portion 24 has oblique belt-like magnetic portions 77 and nonmagnetic portions 78 that have the same length in the circumferential direction as the magnetic portion 77. Each magnetic portion 77 is formed so that magnetic segments 75 and nonmagnetic substances 76 are alternately arranged in the circumferential direction. The nonmagnetic portions 78 are made of a nonmagnetic substance. The synchronization signal generating portion 21 is formed of the magnetic portions 42 and the nonmagnetic portions 43 that have the same length in the circumferential direction as the magnetic portion 42. Each magnetic portion 42 has a plurality of magnetic segments (not illustrated) and a nonmagnetic substance that is arranged to surround the magnetic segments. The magnetic segments 75 of the fine position detecting portion are arranged in the same track at an arrangement pitch (angular phase) p2 that is the same as the arrangement pitch (angular phase) p1 in the circumferential direction of the magnetic portions 42 of the synchronization signal generating portion. By so arranging, when the element of the magnetic head samples a signal of the fine position detecting portion on the basis of the A/D conversion clock signal 71 created from the synchronization signal generating portion, it is possible to operate the magnetic recording apparatus so that the element of the magnetic head does not pass over the nonmagnetic substances 76. That is, when the element of the magnetic head samples a signal of the fine position detecting portion, it is possible to operate the element of the magnetic head so as to pass over the magnetic segments 75.

In FIG. 21, the magnetic segments 75 of the fine position detecting portion are arranged at the same pitch p2 as the pitch p1 in the circumferential direction of the magnetic portions 42 of the synchronization signal generating portion in the same track; instead, the magnetic segments 75 may be arranged as follows. That is, the magnetic segments of the fine position detecting portion may be arranged n times the arrangement pitch (angular phase) in the circumferential direction of the magnetic portions in the synchronization signal generating portion or may be arranged one-nth the pitch (phase) in the circumferential direction of the magnetic portions in the synchronization signal generating portion, where n is natural number. In each case, when the reproducing element of the magnetic head samples a signal of the fine position detecting portion, it is possible to operate the reproducing element so as to pass over the magnetic segments.

In addition, the magnetic segments 75 of the fine position detecting portion 24 and the magnetic segments (not illustrated) of the synchronization signal generating portion 21 may be equal in area of the upper surface with respect to the substrate or may be different in the area.

In FIG. 21, one embodiment of the magnetic recording medium is described by taking the fine position detecting portion, for example, when FIG. 6 is regarded as the existing example. In contrast to the fine position detecting portion when FIG. 5 is regarded as the existing example, or by arranging the magnetic segments as described above in the synchronization signal detecting portion or the address portion in place of the fine position detecting portion, it is possible to obtain the similar advantageous effects.

A method of manufacturing the magnetic recording medium according to the present embodiment is not specifically limited; however, the magnetic recording medium obtained through the following manufacturing method is preferable in terms that it is easy to accurately form a pattern of large-area magnetic substance in a desired shape.

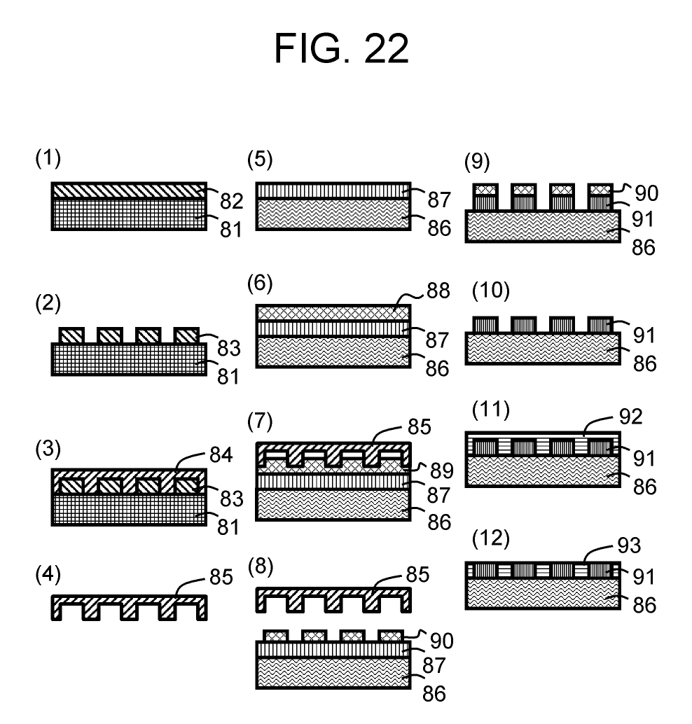

When the magnetic disk medium of patterned media type is manufactured, nanoimprint lithography is generally employed. FIG. 22 is a view that illustrates an example of the steps of manufacturing a magnetic disk medium using nanoimprint lithography. The process of manufacturing a medium using the above method probably employs the following steps.

First, for example, through steps (1) to (4), a stamper for nanoimprinting is formed. (1) A resist 82 is applied on a silicon substrate 81 by spin coat method, or the like. (2) The resist 82 is patterned by electronic beam exposure and development to obtain a patterned resist 83. (3) The resist 83 is plated to form a plated portion 84. (4) The plated portion 84 is peeled from the patterned resist 83 to obtain a nanoimprint stamper 85.

Subsequently, through steps (5) to (12), the magnetic recording medium is created. (5) A layer 87 that is normally formed in the magnetic recording medium, such as a magnetic layer, is deposited on a glass substrate 86. (6) A thermoplastic resin 88 that is resistant against etching performed in step (9) is applied on a magnetic layer and the like 87. (7) The stamper 85 obtained in step (4) is pressed onto the thermoplastic resin 88 while being heated to form a deformed resin layer 89. (8) The stamper 85 is peeled off to leave a patterned resin layer 90. (9) Within the magnetic layer, portions that are not covered with the resin layer 90 are treated with etching to form a patterned magnetic layer 91. (10) The resin layer 90 on the patterned magnetic layer 91 is removed. (11) A nonmagnetic substance 92 is filled on the patterned magnetic layer 91. (12) The surface of the nonmagnetic substance 92 is planarized by polishing process, or the like, to obtain the magnetic recording medium in which the magnetic substance 91 and the nonmagnetic substance 92 are exposed.

Through the above method, the manufacturer is able to arrange magnetic substances on a magnetic disk substrate at selected positions in selected sizes, and the magnetic disk medium of patterned media type may be manufactured. Note that when a UV curing resin is used in place of thermoplastic resin in step (6), a known UV print may be applied in step (7).

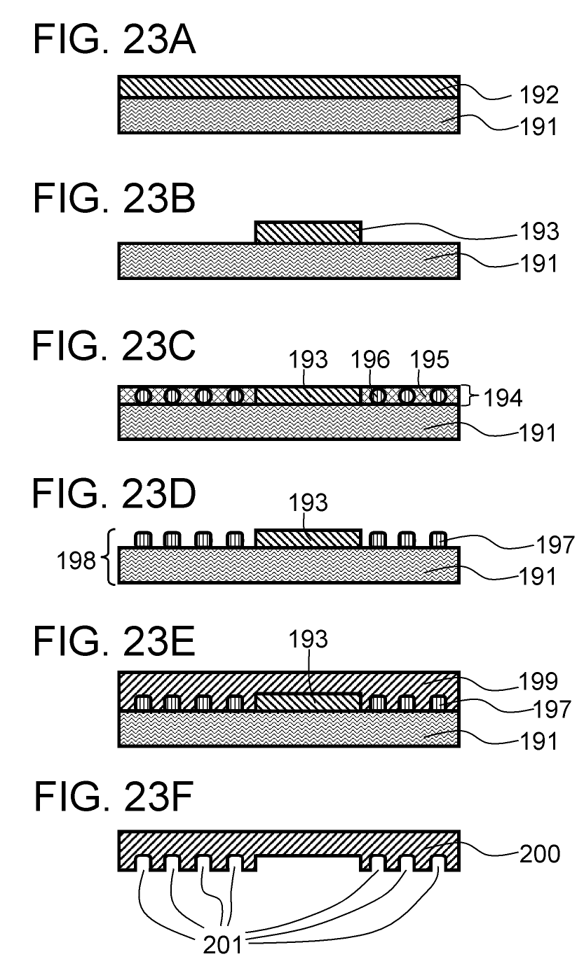

When the magnetic segments having the shape illustrated in FIG. 20 are formed, it is possible to apply a method of creating a stamper using self-organization, which is, for example, described in Japanese Laid-open Patent Publication No. 2005-100499. For example, by creating a servo region formation stamper through the following steps, the magnetic recording medium may be obtained. The method of creating the servo region formation stamper using self-organization will be described with reference to FIG. 23.

(a) A resist 192 is applied on a silicon substrate 191 by spin coat method, or the like. (b) The resist 192 is patterned by electronic beam exposure and development. The nonmagnetic portion (portion corresponding to nonmagnetic information bits) of the servo region and a resist 193 of the portion corresponding to the data region are left on the surface of the substrate 191. (c) Portions at which no resist 193 is left are filled with polystyrene (PS)-polymethylmethacrylate (PMMA) based diblock copolymer as a self-organizing material 194, and is phase-separated by thermal annealing into a matrix portion 195 made of PMMA and a dot portion 196 made of PS. (d) The matrix portion 195 made of PMMA having a high etching rate is removed by RIE (reactive ion etching) to obtain a mold 198 for creating a servo region formation stamper in which dotted protrusions 197 including PS having a low etching rate are formed. (e) Nickel electroforming, or the like, is performed to deposit a Ni layer 199 on the surface of the mold 198 obtained in step (d). (f) The Ni layer 199 is peeled off from the mold 198 to obtain a servo region formation stamper 200 made of nickel. Note that on the surface of the stamper 200, dotted recesses 201 correspond to the magnetic segments of the magnetic recording medium.

Subsequently, a data region formation stamper is prepared. A method of preparing the data region formation stamper may apply either the above described steps (1) to (4) or the steps (a) to (f). When the magnetic segments are arranged by self-organization, a method of arranging the magnetic dots is not specifically limited; however, for example, the magnetic dots may be arranged by self-organization as well as the magnetic segments. In this case, the size of each magnetic segment may be adjusted by adjusting the molecular weight of the self-organizing material. That is, in order to form the magnetic segments that are smaller than the magnetic dots, the molecular weight of the self-organizing material for forming the magnetic segment is set to be smaller than that for forming the magnetic dots. Note that the data region formation stamper may be created separately from the servo region formation stamper; however, on the surface of the servo region formation stamper 200, the steps (1) to (4) or the steps (a) to (f) may be further applied to create a stamper for forming the servo region and the data region.

Next, using the servo region formation stamper and the data region formation stamper, the magnetic recording medium is created in accordance with the steps (5) to (12). That is, in step (7), the servo region formation stamper is pressurized onto the thermoplastic resin 88 while being heated and then the data region formation stamper is pressurized onto the thermoplastic resin 88 while being heated to obtain the deformed thermoplastic resin 89. The order in which the stampers are used may be interchanged.

In the patterned media, because data recording tracks are formed at predetermined positions of the medium, the servo patterns also need to be formed in correspondence with the arrangement of the data recording tracks. For patterned media, creating a stamper that forms a servo pattern together with a data pattern is currently general. However, in the magnetic recording medium of the present embodiment, the magnetic substance of the data region and the magnetic substance of the servo region may be formed by different manufacturing methods as needed.

In the above embodiment, the magnetic disk medium is described as an example of the magnetic recording medium; the shape of the magnetic recording medium according to the aspects of the invention is not limited to a disk shape; but it may be a drum shape.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A magnetic recording medium formed on a substrate comprising:
a data region including a plurality of magnetic dots arranged at predetermined positions on the substrate, for recording information; and
a servo region for specifying the positions of the magnetic dots, the servo region including a plurality of magnetic segments arranged at predetermined positions on the substrate, each of the magnetic segments being smaller than each of the magnetic dots.

2. The magnetic recording medium according to claim 1, wherein each of the magnetic segments has a smaller dimension in at least one direction than each of the magnetic dots.

3. The magnetic recording medium according to claim 1, wherein each of the magnetic segments has a smaller area than each of the magnetic dots.

4. The magnetic recording medium according to claim 1, wherein the magnetic segments make a group of collecting portion for recording a bit of servo information.

5. The magnetic recording medium according to claim 1, wherein the magnetic dots and the magnetic segments are made of a polycrystal magnetic material.

6. The magnetic recording medium according to claim 1, wherein the substrate is disk-shaped, the servo region is arranged intermittently on a substantially circumference having a belt shape, and the data region is arranged at portions on the substantially circumference free of the servo region.

7. The magnetic recording medium according to claim 1, wherein the substrate is disk-shaped, the magnetic dots is arranged intermittently on a plurality of substantially circumferences having belt shapes, and at least one of the magnetic segments is arranged to extend over at least two or more of the substantially circumferences.

8. The magnetic recording medium according to claim 1:
wherein the substrate is disk-shaped, and
further comprising:
a first length of each of the magnetic dots in the circumferential direction; and
a second length of each of the magnetic segments in the circumferential direction, the second length being shorter than the first length.

9. The magnetic recording medium according to claim 1:
wherein the substrate is disk-shaped, and each of the magnetic segments has a rectangular shape; and
further comprising:
a first gap between a first pair of magnetic segments adjacent in the radial direction to each other; and
a second gap between a second pair of magnetic segments adjacent in the radial direction, the second pair being adjacent in the circumferential direction to the first pair, the first gap and the second gap being located at positions that are different in distance from the center of the magnetic recording medium.

10. The magnetic recording medium according to claim 1, wherein the substrate is disk-shaped, and the magnetic segments makes a group of a collecting portion for recording a position of one of the magnetic dots.

11. The magnetic recording medium according to claim 4:
wherein the substrate is disk-shaped, and
further comprising:
another collecting portion adjacent in the circumferential direction to the collecting portion;
a third gap between the magnetic segments adjacent in the circumferential direction to each other in each collecting portion; and
a fourth gap between the collecting portion and the another collecting portion, the fourth gap being larger than the third gap.

12. The magnetic recording medium according to claim 4, wherein the substrate is disk-shaped, and the magnetic segments within the collecting portion are located symmetrically with respect to a straight line that passes through substantially the center of the magnetic recording medium.

13. The magnetic recording medium according to claim 4, wherein the substrate is disk-shaped, and each collecting portion of the magnetic segments has the odd-numbered magnetic segments in the circumferential direction.

14. The magnetic recording medium according to claim 4:
wherein the substrate is disk-shaped, and
further comprising:
another collecting portion adjacent in the radial direction to the collecting portion;
a fifth gap between the magnetic segments adjacent in the radial direction; and
a sixth gap between the collecting portion and the another collecting portion adjacent in the radial direction, the fifth gap being smaller than the sixth gap.

15. The magnetic recording medium according to claim 1, wherein each of the magnetic segments is arranged around nonmagnetic material.

16. The magnetic recording medium according to claim 1, wherein the magnetic dots and the magnetic segments are made of the same material.

17. A magnetic recording apparatus comprising:
a magnetic head having an element for writing or reading magnetic information; and
a magnetic recording medium formed on a substrate, for recording magnetic information, the magnetic recording medium including:
a data region including a plurality of magnetic dots arranged at predetermined positions on the substrate, for recording information, and
a servo region for specifying the positions of the magnetic dots, the servo region including a plurality of magnetic segments arranged at predetermined positions on the substrate, each of the magnetic segments being smaller than each of the magnetic dots.

18. The magnetic recording apparatus according to claim 17, wherein the substrate is disk-shaped, and a length of a gap between the magnetic segments arranged adjacent in the circumferential direction to each other is shorter than the length of the element.

19. The magnetic recording apparatus according to claim 17, wherein the substrate is disk-shaped, and a length of a gap between the magnetic segments arranged adjacent in the radial direction to each other is shorter than the width of the element.
